(19) United States
(12) Patent Application Publication
(10) Pub. No.: US 2013/0095855 A1
(43) Pub. Date: Apr. 18, 2013

(54) Method, System, and Computer Program Product for Obtaining Images to Enhance Imagery Coverage

(71) Applicant: David Bort, Palo Alto, CA (US)

(72) Inventor: David Bort, Palo Alto, CA (US)

(73) Assignee: GOOGLE Inc., Mountain View, CA (US)

(21) Appl. No.: 13/272,556

(22) Filed: Oct. 13, 2011

(51) Int. Cl. H04W 4/02

(52) U.S. Cl. 455/456.2

(57) ABSTRACT

Systems, methods, computer programs, and user interfaces are provided to identify a number of target geographic elements failing to satisfy an image threshold based on spatial data, generate a number of image requests, each of the image requests being associated with a target geographic element of the target geographic elements failing to satisfy the image threshold, transmit an image request of the plurality of image requests to a mobile user device, the image request including a geographic location of the target geographic element, receive an image of the target geographic element from the mobile user device, and store the image in an image repository so that an imagery coverage includes the image of the target geographic element.

### TECHNICAL FIELD

The present disclosure relates to a process for obtaining images for a map service. More specifically, embodiments of the present disclosure use augmented reality to encourage users to provide geographically-located images for target geographic elements.

### BACKGROUND

Photographs of geographically distributed features (e.g., buildings, roads, or natural vistas) are useful in a variety of applications. For example, map services may store images of geographically distributed features and provide those images to users in response to a user request for images near or of a geographic location. The photographs are also useful for constructing 3D models of buildings or natural topographical features and for measuring other attributes of a geographic location, e.g., a number of people or crowd density at a location, a number of cars in a parking lot or lane of traffic, a severity of cloud cover, a count of some set of things at a location, the presence of some particular thing at a location, or dimensions of, or arrangement of, items at a location. The photographs are also useful for documenting the presence of a user at some location, e.g., on a social networking site, or in a game in which the location of a user is an element of game-play.

Certain applications based on images of geographically distributed features often have an incomplete set of images. Certain locations may not be imaged, or certain perspectives of the location may not be imaged. Or the images of a location may lack desirable attributes, such as an image captured at a particular time, a desired image clarity, a desired image resolution, etc.

### SUMMARY

Various embodiments of systems, methods, computer programs, and user interfaces for obtaining images for a map service are described herein. In some aspects, provided are a system, method, computer program, and user interface for identifying the target geographic elements failing to satisfy an image threshold based on spatial data, generating a number of image requests, each of the image requests being associated with one of the target geographic elements failing to satisfy the image threshold, transmitting an image request of the image requests to a mobile user device, the image request including a geographic location of a target geographic element of the target geographic elements, receiving an image of the target geographic element from the mobile user device, and storing the image in an image repository so that an imagery coverage includes the image of the target geographic element.

In some aspects, the system, method, computer program, and user interface are further for determining that the image satisfies criteria of the target geographic element, the criteria including at least one of a resolution criterion, a location criterion, a composition criterion, a quality criterion, and a time criterion, where the image is associated with the target geographic element after determining that the image satisfies the criteria.

In some aspects, the image request further includes a user reward for obtaining the image of the target geographic element. In some aspects, the system, method, computer program, and user interface are further for receiving an initial location of the mobile user device from the mobile user device and selecting, for transmitting to the mobile user device, the image request from the image requests based on the initial location.

In some aspects, the user reward is determined based on a distance between the initial location and a target location of the image. In some aspects, the system, method, computer program, and user interface are further for determining revised target geographic elements failing to satisfy the image threshold based on the image and generating a number of revised image requests, each of the revised image requests being associated with one of the revised target geographic elements.

In some aspects, the system, method, computer program, and user interface are further for transmitting candidate geographic elements to a user of a map service and receiving selected target geographic elements from the user of the map service. In some aspects, the user reward is determined based on a quantity of the users of the map service requesting the image of the target geographic element.

In some aspects, the geographic location includes geographic coordinates from which a display of the mobile device is formed. In some aspects, the target geographic element is a target point of interest, where the image is stored after determining that the image depicts the target point of interest.

In some aspects, determining that the image depicts the target point of interest includes receiving orientation information and an image location of the image from the mobile user device and determining the image depicts the target point of interest based on the orientation information and the image location. In some aspects, determining that the image depicts the target point of interest includes performing object recognition on the image to identify the target point of interest in the image.

In some aspects, the target geographic element is a target point of interest or a target geographic area. In some aspects, the target geographic element is a target geographic area, and where the image threshold specifies a minimum quantity of images for the target geographic area.

### BRIEF DESCRIPTION OF THE DRAWINGS

FIGS. 1 and 2A-2D show diagrams of systems in accordance with one or more embodiments.

FIGS. 3-4 show flow charts in accordance with one or more embodiments.

FIG. 5 shows a data flow diagram in accordance with one or more embodiments.

FIG. 6 shows an example user interface in accordance with one or more embodiments.

While obtaining images to enhance imagery coverage is susceptible to various modifications and alternative forms, specific embodiments thereof are shown by way of example in the drawings and will herein be described in detail. The drawings may not be to scale. It should be understood, however, that the drawings and detailed description thereto are not intended to limit obtaining images to enhance imagery coverage to the particular form disclosed, but to the contrary, the intention is to cover all modifications, equivalents, and alternatives falling within the spirit and scope of the present disclosure as defined by the appended claims.

### DETAILED DESCRIPTION

As discussed in more detail below, provided in some embodiments are systems and methods for obtaining images at geographic locations (e.g., geographic regions, geographic points, geographically positioned features), which may be useful for a map service, social networks, or other applications in which images at geographic locations are presented or analyzed. In one embodiment, the process for obtaining images for a geographic location service (e.g., map service, navigation service, etc.) includes the steps determining, based on spatial data, a target geographic element for which images are not stored in memory, sending a request for an image of the target geographic element to a mobile user device, receiving the requested image from the mobile user device, and storing the image in an image repository. Further, in some embodiments, the stored image is associated with the target geographic element, e.g., in the image repository.

Examples of target geographic elements are points of interest and target geographic areas. A point of interest may include geographic coordinates and associated metadata describing the point of interest. For instance, a discrete building, natural feature, restaurant, tourist attraction, artwork, bridge, or other notable geographic location may be represented as a point of interest. A geographic area may include a polygon and associated metadata describing the geographic area. Target geographic areas may represent stretches of road, city blocks, counties, neighborhoods, etc. The target geographic elements are determined based on spatial data by performing a query to obtain geographic elements for which no images are stored in memory (e.g., a query for points of interest or geographic areas that are not related to images).

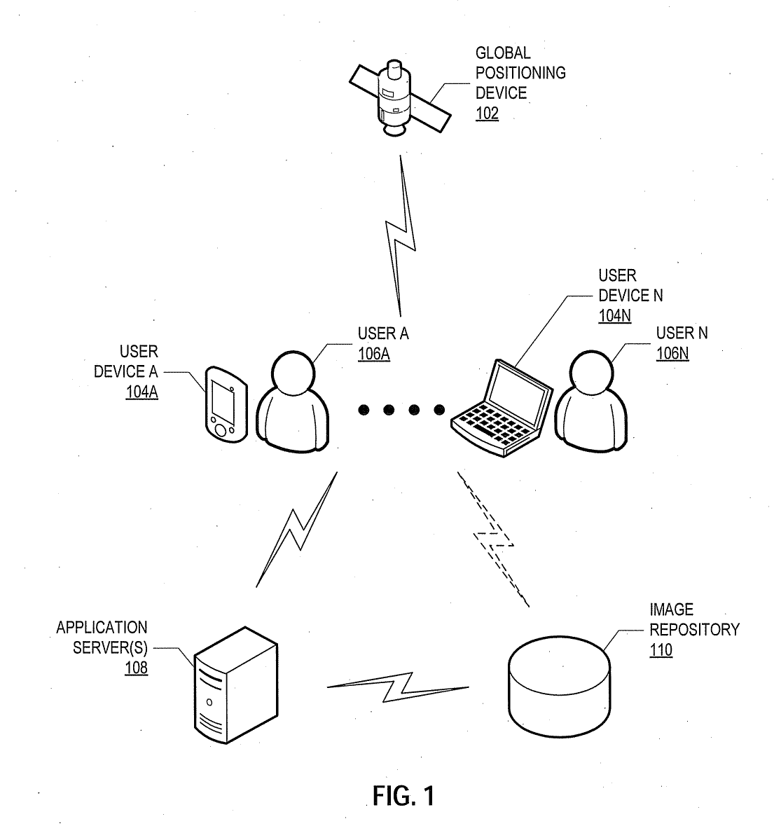

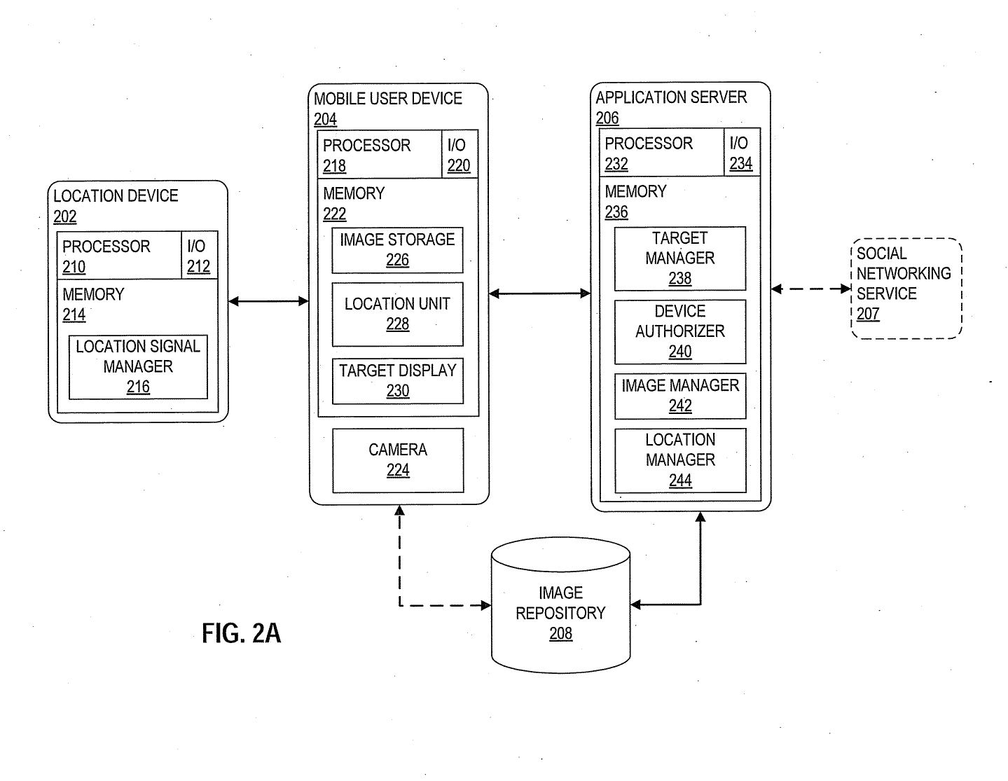

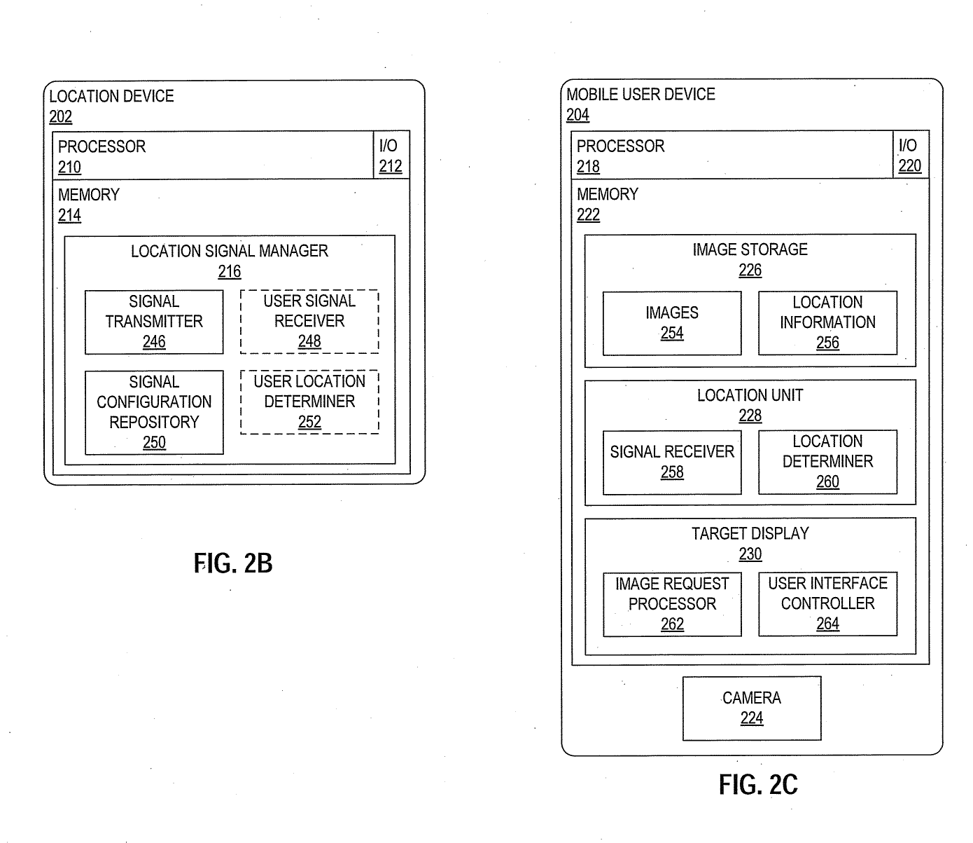

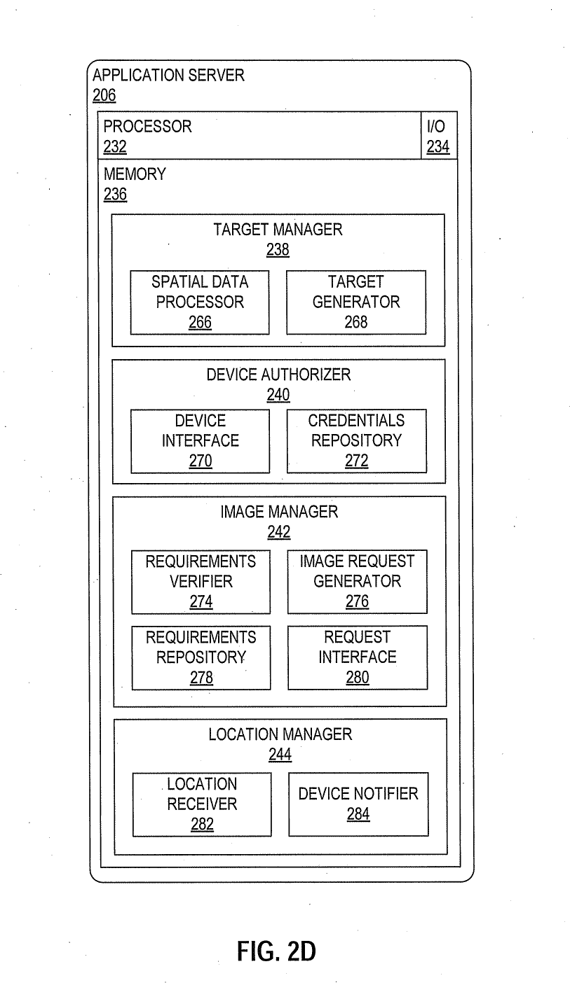

FIG. 1 shows a diagram of a system in accordance with one embodiment. The system of this embodiment includes a positioning device 102 interacting with user devices (e.g., user device A 104A and user device N 104N), which in turn interface with application server(s) 108. Further, the illustrated application server 108 stores information in an image repository 110. FIG. 2 describes further aspects of the aforementioned components of FIG. 1.

In some embodiments, the global positioning device 102 broadcasts radio frequency (“RF”) signals that may be received by a number of user devices (e.g., user device A 104A, user device N 104N). As discussed below with respect to FIG. 2, the positioning device 102 may be part of a global positioning system (“GPS”) including multiple satellites. Each of the user devices (e.g., user device A 104A, user device N 104N) may use the RF signals to deter mining their location, e.g., their global geographic location or their geographic location relative to some reference point, such as a center of a city, a building, or some arbitrarily selected reference.

Examples of user devices (e.g., user device A 104A, user device N 104N) include smartphones, tablet computers, laptop computers, etc. Each of the user devices (e.g., user device A 104A, user device N 104N) is equipped with a camera configured to capture images. The user devices may then geo-locate the captured images using the location obtained from the positioning device 102. As shown in FIG. 1, the user devices (e.g., user device A 104A, user device N 104N) in this example are operated by users (e.g., user A 106A, user N 106N).

In some embodiments, the application server(s) 108 may include a map service server, an image service server, and a social networking service server. Each of the application server(s) 108 may be may be implemented on multiple computing devices (i.e., servers), where a load balancing scheme distributes requests across the multiple computing devices. The image service server 108 is substantially similar to the application server (206 of FIG. 2) discussed below with respect to FIG. 2. The map service server 108 is configured to provide spatial data (e.g., maps, geographic coordinates, directions, etc.) to the user devices (e.g., user device A 104A, user device N 104N). For example, the map service server 108 may provide a map displayed on user device A 104A, where user A 106A uses the map to locate a nearby point of interest. Alternatively or additionally, the map service server 108 may, in some embodiments, also provide images for the points of interest, such as images of a building, path, road, waterway, or other feature, which are viewed by the user A 106A on the user device A 104A. The map service server 108 may be configured to obtain images for maps from the image repository 110. In some embodiments, additional repositories at the same or different location as the image repository 110 may also be queried by the map service server 108 to generate maps of the points of interest or geographic areas for the user devices (e.g., user device A 104A, user device N 104N).

In some embodiments, the image service server 108 is configured to obtain and store images. The stored images may be later transmitted by the map service server 108 in response to requests from user devices for images of locations depicted in the images, or the stored images may be analyzed by an image-analysis module to generate data based on the images, e.g., to construct a 3D model of a structure by performing a bundle adjustment with stored images from a variety of perspectives, to count some number of objects within an image at a location (such as a number of people attending an event, a number of cars in a parking lot, or a number of items in inventory). Specifically, in this embodiment, the image service server 108 is configured to generate image requests for points of interest or geographic areas (or perspectives of the same) for which the image service server 108 lacks images or lacks images with a desired image attribute (e.g., clarity, depth of focus, orientation, framing, resolution, dynamic range, exposure time, or noise level) and to send the image requests to the appropriate user devices (e.g., user device A 104A, user device N 104N). The image requests are expected to encourage the users (e.g., user A 106A, user N 106N) to obtain images for the points of interests or geographic areas lacking images.

For example, if user A 106A is traveling in Paris, France, the image service server 108 may receive a notification from user device A 104A including the current geographic location of user A 106A, e.g., a user A 106A may be located close to the Eiffel Tower. In this example, the user device A 104A may be configured to send the notification after the user A 106A elects to participate in the image request service. The image service server 108 may then search for image requests located near the Eiffel Tower and discover that no images of the Eiffel Tower (a point, of interest) exist in the image repository. For example, the image requests located near the Eiffel Tower may be obtained by performing a spatial query for image requests within a threshold distance of the current geographic location of user A 106A.

In response to discovering that there are no images of the Eiffel tower (for example, in response to this discovery and other factors, or solely in response to this discovery), the image service server 108 may send an image request for an image of the Eiffel Tower to the user device A 104A. The user device A 104A may then direct the user A 106A to capture an image of the Eiffel Tower, which is submitted to the image service server 108. After the image service server 108 determines that the image satisfies the criteria for the point of interest, the image service server 108 may award a user reward to the user A 106A, who receives notification of the user reward on the user device A 104A.

As images are received by the image service server 108, in some embodiments, the images are stored in the image repository 110, and the image service server 108 may reevaluate the points of interests and geographic areas to determine new target geographic elements that are lacking images. Further, the image service server 108 may also evaluate whether certain images are stale (e.g., older than a threshold time specified in days, months, years, etc., where the threshold time may be dynamically determined based on rate of images previously received by the image service server 108), and in response to a determination that an image is stale, the image service server 108 may generate an image request to obtain updated images for geographic elements (e.g., points of interest, geographic areas).

FIG. 2A shows a diagram of a system in accordance with some embodiments of obtaining images to enhance imagery coverage. The example system includes a location device 202 communicating with (e.g., interacting, receiving broadcasts from, or transmitting broadcasts to) a mobile user device 204, which in turn interfaces with an application server 206. Further, the application server 206 of this embodiment stores information in an image repository 208 and interacts with a social networking service 207.

In some embodiments, the location device 202 is configured to provide location information indicative of the location of the mobile user device 204. Specifically, the location signal manager 216 of the location device 202 may include a signal transmitter 246 of FIG. 2B configured to provide radio frequency (“RF”) signals to the mobile user device 204, where the RF signals allow the mobile user device 204 to determine a global location of the mobile user device 204. For example, the location device 202 may correspond to the global positioning system (GPS), which includes multiple satellites that broadcast RF signals and navigation messages. In this example, the RF signals are used by the mobile user device 204 to determine the distance to a satellite, and the navigation messages are used to determine the location of each of the satellites. In another example, the location device 202 may correspond to mobile network towers, where the signal strengths of the mobile network towers with respect to the mobile user device 204 are used to determine a location of the mobile user device 204. Examples of communication standards implemented on mobile network towers include 3^{rd} generation mobile telecommunications standards (3G) and 4^{th} generation mobile telecommunication standards (4G) such as long term evolution (LTE) and worldwide interoperability for microwave access (WiMAX), etc. In some embodiments, the signal configuration used by the signal transmitter 246 of FIG. 2B is stored in the signal configuration repository 250 of FIG. 2B. For example in the case of GPS, the signal configuration repository 250 stores (1) orbital information of the location device 202 and (2) general system health and rough orbits of all the GPS satellites.

As shown in FIG. 2B, the location signal manager 216 may include a user signal receiver 248 of FIG. 2B configured to receive an RF signal. For example, if the location device 202 is the GPS, the user signal receiver 248 of FIG. 2B is configured to receive GPS signals from GPS satellites, where a user location determiner 252 of FIG. 2B is configured to determine a global location of the mobile user device 204 based on the GPS signals. In another example, if the location device 202 is a mobile network tower, the user signal receiver 248 of FIG. 2B is configured to receive an RF signal from the mobile user device 204, where the user location determiner 252 of FIG. 2B is configured to determine a relative location of the mobile user device 204 based on the strength of the RF signal. In some embodiments, the user signal receiver 248 of FIG. 2B is configured to receive signals from multiple sources (e.g., GPS signals, RF signals from mobile network towers or wireless access points) in which case the user location determine 252 of FIG. 2B is configured to determine the location by applying a hybrid positioning algorithm to all the signals.

In some embodiments, the location device 202 includes a processor 210, an input/output module 212, and memory 214. The location device 202 may include various types of computing devices that execute an operating system. The processor 210 may execute instructions, including instructions stored in the memory 214. The instructions, like the other instructions executed by computing devices herein, may be stored on a non-transitory computer readable medium such as an optical disk (e.g., compact disc, digital versatile disk, etc.), a flash drive, a hard drive, or any other computer readable storage device. The input/output module 212 of the location device 202 may include an input module, such as a radio frequency sensor, a keyboard, and/or a mouse, and an output module, such as a radio frequency transmitter, a printer, and/or a monitor. The location device 202 may be connected to a local area network (LAN) or a wide area network (e.g., the Internet) via a network interface connection. In some embodiments, the input/output module 212 may take other forms.

Further, the location device 202 may be implemented as a node of a distributed system, where the other portions of the distributed system are located on different nodes. The nodes of the distributed system may correspond to computing devices as discussed above. Alternatively, the nodes of the distributed system may correspond to multiple processors/cores with shared memory in a single computing device.

In some embodiments, the mobile user device 204 is a mobile personal computer. For example, the mobile user device 204 may be a laptop computer, a smartphone, a tablet computer, a navigation device, a wirelessly-networked imaging device, a wirelessly-networked e-reader, an on-board computer of a vehicle, or other device configured to be readily transported with a user over distance while maintaining a connection to a network. In some embodiments, the mobile user device 204 includes a camera 224 configured to capture images, such as in a video format or as still images, including stereoscopic video or still images. For instance, the camera 224 may include one or more image sensors configured to capture images of light within the visible spectrum for use by the mobile user device 204.

In some embodiments, the mobile user device 204 includes a processor 218, an input/output module 220, and a memory 222. The mobile user device 204 may be implemented as a computing device with an operating system, stored in the memory 222, for interacting with a user. For example, the operating system may be configured to provide applications (e.g., map application, social networking application, etc.) to the user. In some embodiments, the memory 222 includes an image storage module 226, a location unit 228, and a target display module 230.

In some embodiments, the image storage module 226 of the mobile user device 204 is configured to manage the images captured by the camera 224. For example, the image storage module 226 may be configured to (1) store images 254 of FIG. 2C captured by the camera 224; (2) associate location information 256 of FIG. 2C with the stored images 254 of FIG. 2C; and/or (3) transmit the stored images 254 of FIG. 2C to the application server 206. Location information 256 of FIG. 2C may be embedded in the metadata (e.g., longitude and latitude) of the stored images 254 of FIG. 2C. In other embodiments, location information 256 of FIG. 2C may be stored separately from a stored image 254 of FIG. 2C, where both are transmitted in a single unit as a geographically-located image. The location information 256 of FIG. 2C may be obtained for the mobile user device 204 as discussed below with respect to the location unit 228. In some embodiments, the stored images 254 of FIG. 2C and location information 256 of FIG. 2C may be stored on a local, tangible storage medium (e.g., random access memory, flash memory, etc.) of the mobile user device 204.

In some embodiments, the location unit 228 of the mobile user device 204 is configured to obtain a location of the mobile user device based on location information received from the location device 202. Specifically, the location unit 228 may include a location determiner 260 of FIG. 2C configured to determine a global location of the mobile user device 204 based on location information received from the location device 202. For example, the location determiner 260 of FIG. 2C may determine the absolute location of the mobile user device 204 based on GPS signals received from GPS satellites using the signal receiver 258 of FIG. 2C. In this example, the absolute location may be geographic coordinates identifying the location of the mobile user device 204 in a geographic coordinate system. In another example, the location determiner 260 of FIG. 2C may triangulate the relative location of the mobile user device 204 based on mobile phone signals received from one or more mobile network towers. In this example, the relative location may specify the location of the mobile user device 204 with reference to the mobile network towers.

Once the location determiner 260 of FIG. 2C determines the location of the mobile user device 202, the location may be provided to the image storage module 226, which may then associate the location with an image captured by the camera 224. The image storage module 226 may also associate other data with the image, e.g., the time at which the image was captured and data indicative of the accuracy of the location, such as a tolerance indicating that the location is accurate within some radius of the actual location of the mobile user device. In some embodiments, camera settings and attributes of the mobile user device at the time the image was captured may also be associated with the image by the image storage module. For instance, the mobile user device may include an accelerometer (such as a 3-axis accelerometer or a 6-axis accelerometer), and based on signals from the accelerometer, aspects of the orientation of the user module, such as the altitude and orientation between a portrait or landscape view (e.g., angular position of the image sensor about a horizontal axis) of the mobile user device may be associated with the image by the image storage module. The mobile user device may also include a magnetometer or other sensor configured to determine the azimuth of the mobile user device at the time the image is captured. The azimuth may also be associated with the image by the image storage device. Alternatively or additionally, settings of the camera may be associated with the image by the image storage module, such as resolution, exposure time, aperture, depth of focus, and post processing settings, such as white balance, compressing settings, and sharpness adjustments. In the examples above, the signal receiver 258 of FIG. 2C is configured to receive RF signals from the signal transmitter 246 of the location device 202.

In some embodiments, the target display module 230 of the mobile user device 204 is configured to extract target information from image requests received from the application server 206. The target display module 230 may include an image request processor 262 of FIG. 2C configured to receive image requests (further discussed below) requesting images for target geographic elements (e.g., target points of interest, target geographic areas). For example, the image request processor 262 of FIG. 2C may receive an image request requesting an image of a building (which is an example of a point of interest). In another example, the image request processor 262 of FIG. 2C may receive an image request requesting images for any points of interest within a target geographic area.

In some embodiments, an image request includes one or more of the following elements to define the requested image: (1) requested location of the target geographic element; (2) requested height of the camera; (3) requested azimuth and altitude of the optical axis of the camera; (4) requested time at which to capture the image; (5) requested boundaries of the image; and (6) an image request identifier (e.g., globally unique identifier, numeric identifier, etc.). For video, the image request may include an array of the preceding elements that define requested still images that should occur at predetermined intervals during the video.

In some embodiments, the target display module 230 further includes a user interface controller 264 of FIG. 2C configured to use the image request to display guidance for capturing the image on a display screen (not shown) of the mobile user device 204. For example, the user interface controller 264 of FIG. 2C may superimpose a graphical highlight in a video stream from the camera 224 at a target point of interest specified in the image request, where the graphical highlight remains generally fixed to the target point of interest in the video stream as the mobile user device 204 is repositioned. In this example, the video stream obtained by the camera 224 may be analyzed by the user interface controller 264 of FIG. 2C to identify and track the target point of interest in the video stream. Further, the user interface controller 264 of FIG. 2C may analyze the position and orientation (obtained from, for example, accelerometers) of the camera to identify and track the target point of interest. In another example, the user interface controller 264 of FIG. 2C may display an indication of the direction of the target point of interest, where the indication of the direction is updated in real-time as the mobile user device 204 is repositioned by the user.

In some embodiments, the user interface controller 264 of FIG. 2C of the target display module 230 is further configured to display confirmation of a user reward on a display screen of the mobile user device 204. For example, a user reward may be included in the image request received from the application server 206. In this example, the user interface controller 264 of FIG. 2C displays confirmation that the user reward has been awarded in response to confirming the requested image is captured. In another example, a user reward is received from the application server 206 after the mobile user device 204 sends the requested image to the application server 206.

In some embodiments, the application server 206 is a computing device configured to provide application services (e.g., image services, map services, etc.) to a number of client devices such as the mobile user device 204. In some embodiments, the application server 206 includes a processor 232, an input/output module 234, and a memory 236. The application server 206 may be implemented as a computing device with similar characteristics as discussed above with respect to the location device 202. In some embodiments, the memory 236 includes a target manager module 238, a device authorizer 240, an image manager 242, and a location manager 244. The aforementioned components of the application server 206 may be implemented on multiple computing devices (i.e., servers), where a load balancing scheme distributes requests across the multiple computing devices.

In some embodiments, the target manager module 238 of the application server 206 is configured to identify target geographic elements (e.g., points of interest, geographic areas). A target point of interest may be a point of interest (e.g., hotel, restaurant, tourist attraction, etc.) that lacks an associated image. A target geographic area may be a geographic area (e.g., county, city, zip code, neighborhood, etc.) failing to satisfy an image threshold, where the image threshold specifies a minimum quantity of images for the geographic area. For example, the image threshold may specify a minimum density of images for the geographic area. The target manager module 238 may include a target generator 268 of FIG. 2D configured to identify target geographic elements (e.g., target points of interest, target geographic areas) by analyzing spatial data in a map layer. For example, the target generator 268 of FIG. 2D may use a spatial data processor 266 of FIG. 2D to identify target points of interest lacking images in a map layer of points of interest. In another example, the target manager module 238 may use the spatial data processor 266 of FIG. 2D to identify target geographic areas failing to satisfy an image threshold in a map layer of geographic areas. In this example, geographic areas, (e.g., polygons) in the map layer may be used by the spatial data processor 266 of FIG. 2D to perform a spatial query of geo-located images to determine the target geographic areas failing to satisfy an image threshold. In some embodiments, a map layer includes spatial features (e.g., points, polylines, polygons, vectors, etc.) of a data type (e.g., cities, rivers, state boundaries, etc.) for presenting in a map. For example, a library map layer may include points of interest for libraries in a geographic area. In another example, a county map layer may include county boundaries for counties in a geographic area.

In some embodiments, an image request for a target geographic area may include one or more of the following elements to define the requested images: (1) requested geographic area for obtaining images; (2) requested height of the camera; (3) requested azimuth and altitude of the optical axis of the camera for each of the images; (4) requested time period in which to capture the images; (5) requested boundaries for each of the images; and (6) an image request identifier (e.g., globally unique identifier, numeric identifier, etc.).

In some embodiments, spatial data describes the geographic location of features (e.g., points of interest, cities, geo-located images, etc.) and boundaries (e.g., rivers, county boundaries, state boundaries, country boundaries, etc.). Typically, spatial data is stored in the form of points, polylines, polygons, vectors, imagery, or some other shape. For example, geographic coordinates and associated metadata for points of interest may be stored in a point map layer. In another example, boundaries and associated metadata for geographic areas may be stored in a polygon map layer. Spatial queries may be performed between mapping layers by performing spatial comparisons (e.g., comparisons for intersections, comparisons for disjointedness, etc.) of the shapes in each of the mapping layers.

In some embodiments, the device authorizer module 240 of the application server 206 is configured to manage user sessions for user devices (e.g., mobile user device 204). For example, the device authorizer module 240 of this embodiment includes a device interface 270 of FIG. 2D configured to authenticate credentials from the mobile user device 204 when initiating a user session. In this example, the mobile user device 204 is not authorized to interact with the application server 206 until the credentials are confirmed to be valid by the device interface 270 of FIG. 2D. In some embodiments, the device authorizer 240 also includes a credentials repository 272 of FIG. 2D configured to store encrypted credentials used to authorize the users of the application server 206.

In some embodiments, the device interface 270 of FIG. 2D of the device authorizer module 240 of the application server 206 may also be configured to interact with a social networking service 207 on behalf of the mobile user device 204. In this case, the device interface 270 of FIG. 2D is configured to request authorization to access the social networking service 207 from the mobile user device 204. Once authorized, the device interface 270 of FIG. 2D may interact with the social networking service 207 to provide social rewards (further discussed below) in response to images provided by the mobile user device 204.

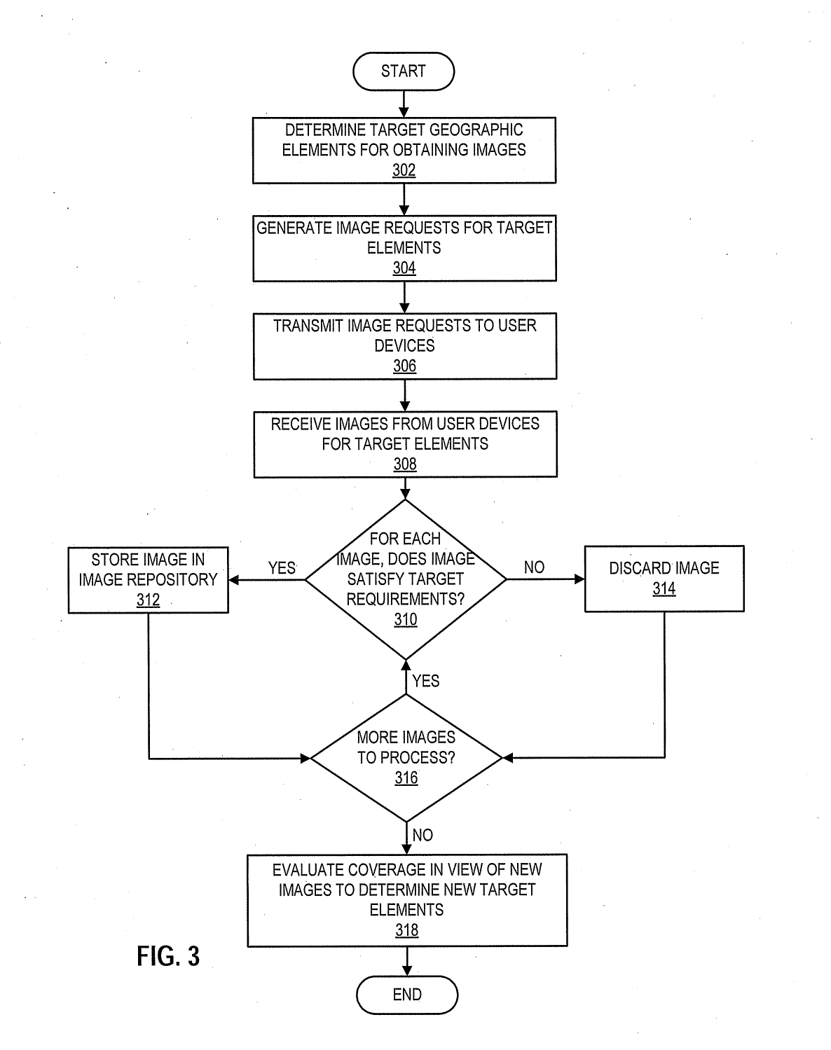

In some embodiments, the image manager module 242 of the application server 206 is configured to manage image requests for user devices (e.g., mobile user device 204). Specifically, the image manager module 242 may include: (1) an image request generator 276 of FIG. 2D configured to generate image requests based on target geographic elements (e.g., target points of interest, target geographic areas) identified by the target manager module 238; (2) a request interface 280 of FIG. 2D configured to submit image requests to the mobile user device 204 based on a location of the mobile user device 204 and to receive images from the mobile user device 204 in response to the image requests; and (3) a criteria verifier 274 of FIG. 2D configured to determine whether the images satisfy target point of interest criteria or target geographic area criteria and to store approved images in the image repository 208. In some embodiments, the image manager module 242 may further include a criteria repository 278 of FIG. 2D, which may be configured to store target geographic elements criteria used by the criteria verifier 274 of FIG. 2D to verify the images as discussed below with respect to 310 of FIG. 3.

In some embodiments, the image repository 208 is configured to store images for use by a map service. The stored images are related to location information (i.e., geographic coordinates), allowing the map service to use the stored images as spatial data for generating maps. The image repository 208 may correspond to a server, a database, files, a memory cache, etc. that is stored locally (e.g., located on the application server) or shared on a network (e.g., a database server). The mobile user device 204 may interact directly with the image repository 208 to store images captured in response to image requests. In some embodiments, metadata associated with the stored images is stored in a separate repository (not shown). For example, the image repository 208 and the separate repository may be organized in a distributed relational database architecture.

In some embodiments, the image repository 208, or a related repository, is configured to store information related to the stored images. For example, the image repository 208 may also store results of analysis (e.g., object recognition, etc.) performed on the stored images. In another example, the image repository 208 may also store metadata (e.g., geographic location of image, timestamp of image, format of image, etc.) related to the stored images.

In some embodiments, the location manager module 244 of the application server 206 may be configured to manage location information from user devices (e.g., mobile user device 204). The location manager module 244 may include a location receiver 282 of FIG. 2D configured to receive location information from the mobile user device 204, where the location information is used to identify target points of interest that are in geographic areas near the mobile user device 204. In this case, the location receiver (282 of FIG. 2D) may be configured to anonymize the location information before it is stored to protect the identity of the user. For example, personal data identifying the user is stripped from the location information before the location information is stored in the memory 236. Further, the location information may only be obtained from the mobile user device 204 if the user elects to participate in image collection for the application server 206. The location manager module 244 may also include a device notifier 284 of FIG. 2D configured to monitor the location of user devices (e.g., mobile user device 204), allowing the target manager module 238 to send nearby image requests when a user mobile device 204 enters a geographic area.

FIG. 3 shows a flow chart in accordance with certain embodiments. More specifically, FIG. 3 is a flow chart of a method performed by an application server for obtaining images for a map service. The images may be obtained for a map service or for other purposes. As is the case with the other processes described herein, various embodiments may not include all of the steps described below, may include additional steps, and may sequence the steps differently. Accordingly, the specific arrangement of steps shown in FIG. 3 should not be construed as limiting the scope of obtaining images to enhance imagery coverage.

In step 302 of this embodiment, target geographic elements for obtaining images are determined. For example, the target geographic elements (e.g., target points of interest, target geographic areas) are determined based on spatial data to identify points of interest or geographic areas lacking images. With respect to points of interests, target points of interests may be identified as points of interest lacking stored images. With respect to geographic areas, target geographic areas may be identified as geographic areas failing to satisfy an image threshold, where the image threshold specifies a certain quantity of stored images for the geographic area. For example, an image threshold may specify that a stored image should be associated with each painting of a museum (which is an example of a geographic area). In another example, an image threshold may specify a minimum quantity of images within a geographic area, such as 1 kilometer stretch of road, a 10-square meter block, a room of a building, a city block, a zip code, a county, or a city. Alternatively, target geographic elements may also be specified by users of the map service. Specifically, users of the map service may request images for points of interest or geographic areas by making selections on maps showing candidate geographic elements from the map service. These requested targets may be stored in memory and compared to location data from other users as described above.

In step 304 of the present embodiment, image requests for the target geographic elements are generated. Each image request may include information describing target geographic element (e.g., target point of interest, target geographic area), a user reward, target criteria, and an image request identifier. The information related to the target geographic element specifies a geographic location (which may be expressed in geographic coordinates, such as latitude and longitude, or in relative terms as a vector from some other geographic location) or a geographic area (which may be expressed as ranges of geographic coordinates, a radius around a geographic coordinates, a or other designations of geographic locations) for the image requested by the image request.

In some embodiments, the information related to the user incentive may describe the reward (e.g., gaming achievement or trophy, social networking service reward, monetary payment, provision of free services, etc.) to be awarded to the user after the image is provided. Alternatively, the image request may not include information related to the user incentive. For example, the application server may not rely on user incentives to encourage users to obtain images. In another example, a game reward awarded to the user for obtaining the image may be provided by a gaming application of the mobile user device.

The information related to the target criteria of the present embodiment describes the criteria that the image should satisfy before the application server stores the image for use in a map service. Examples of target criteria include a resolution criterion (e.g., minimum resolution, maximum resolution), a location criterion (e.g., whether the image was obtained at the requested location or within the requested geographic area), a composition criterion (e.g., whether the camera had the proper orientation when the image was captured), a quality criterion (e.g., verification of image quality characteristics such as clarity, lighting, color, etc.), a time criterion (e.g., whether the image was captured within a requested time frame), etc.

In step 306 of this embodiment, image requests are transmitted to user devices. For instance, the image requests may be transmitted to local applications executing on the user devices. For example, a local application on a user device may monitor the location of the user device, where image requests in proximity of the location are provided to the user device. The location application only monitors the location of the user device if the user has elected to participate in obtaining images for the application server. In this example, the local application notifies the user of the image requests and invites the user to obtain images to fulfill the image requests.

In step 308 of the present embodiment, images from the user devices are received for the target geographic elements. For example, a mobile user device may notify a user of an opportunity to provide a geo-located image in response to an image request, and the user may capture the requested image and return the captured image with the user device or through another channel, e.g., by uploading the image on a desktop computer along with a request identifier. In this example, the geo-located image may be initially processed by associating the image with the image request using the image request identifier, which may also be provided by the user device with the captured image. Further, the geo-located image from the mobile user device may also be associated with a user identifier identifying the user that captured the image. The user identifier may be generated when the user elects to participates in obtaining images by registering and creating a user account with the application server.

In some embodiments, geo-located images may include geographic information (e.g., geographic coordinates) embedded in the image or separate geographic information associated with (e.g., accompanying) the image. As images are received from multiple mobile user devices, the images and associated information may be queued and further processed as discussed below.

In step 310 of this embodiment, each of the images received in step 308 is analyzed to determine if the image satisfies target criteria. As discussed above, the image may have target point of interest criteria or target geographic area criteria, such as a resolution criterion, a location criterion, a composition criterion, a quality criterion, and a time criterion. The criteria may be configured (e.g., pre-configured) by users of the map service or administrators of the application server, where the application server may be implemented as multiple servers For example in the case of user-defined target geographic elements, the users of the map service may select parameters for one or more of the target criteria. In another example, administrators of the application server(s) may define default parameters for one or more of the target criteria that apply to all or a subset of image requests.

If the image satisfies the target criteria, in this embodiment, the image is stored in an image repository in step 312. When the image is stored in the image repository, the image may be associated with a point of interest or geographic area and included in the coverage of images for the map service. For example, the image repository may associate the image with a point of interest or geographic area based on a request identifier of the initial image request. In another example, the image repository may associate the image with a point of interest or geographic area based on geographic information provided with the image. In some embodiments, if the image does not satisfy the target criteria, the image is discarded in step 314, or the image may be stored and the request may be re-issued to another user. The mobile user device that provided the image may be notified that the image was discarded, and the notification may specify the target criteria that were not satisfied instruct the mobile device to request the user to capture a new image.

In step 316, a determination is made as to whether there are more images to process. If there are more images to process, the workflow returns to step 310 for processing the additional images. Alternatively, if there are no more images to process, the workflow proceeds to step 318.

In step 318, the coverage of images is reevaluated in view of the new images to determine new target geographic elements. For instance, after the images are stored and ready for use by the map service, target geographic elements are identified with a process similar to the process discussed above in step 302. For example, the coverage of images may be reevaluated on a periodic basis (e.g., hourly, daily, weekly, monthly, etc.). In another example, the coverage of images may be reevaluated in response to obtaining a predetermined quantity of images (e.g., in response to the storage of 1000 new captured images). Further, once the new target geographic elements are identified, the process may continue as described above in steps 304-316 for the new target geographic elements (e.g., target points of interest, target geographic areas). In some embodiments, the determining of target geographic elements and the obtaining of images as discussed above may be an iterative process that generally continuously collects images for use by the map service.

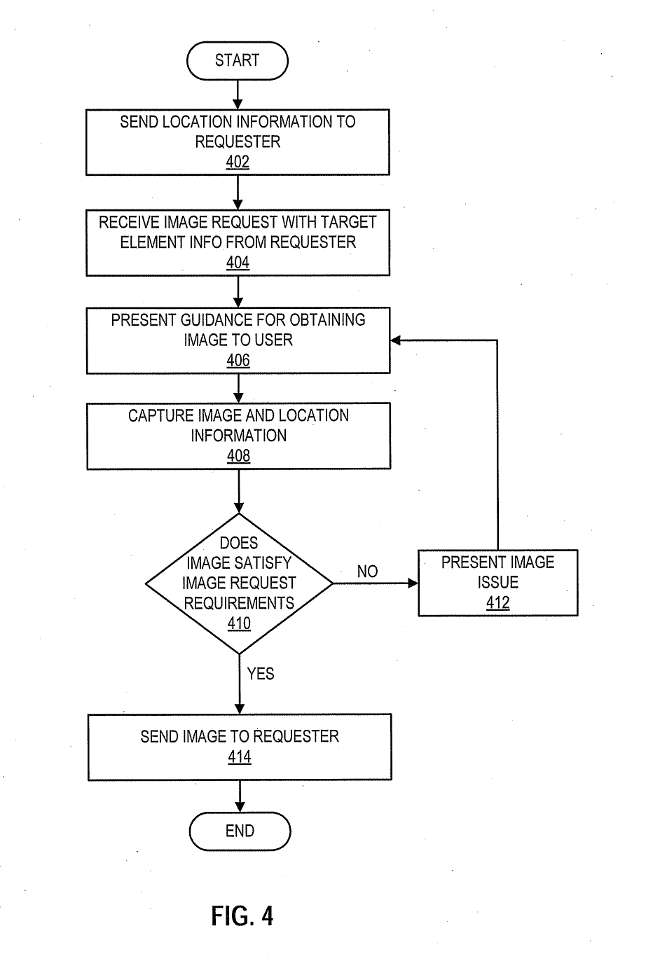

FIG. 4 shows a flow chart in accordance with certain embodiments of obtaining images to enhance imagery coverage. More specifically, FIG. 4 shows a flow chart of a method performed by a mobile user device for obtaining images for an application server. In one or more embodiments, one or more of the steps described below may be omitted, repeated, or performed in a different order. Accordingly, the specific arrangement of steps shown in FIG. 4 should not be construed as limiting the scope of obtaining images to enhance imagery coverage.

In step 402 of the present embodiment, location information is sent to the requester of images. The requester of images may be an application server, such as one of the examples of application servers described above with respect to FIGS. 1 and 2. In some embodiments, the location information may include geographic coordinates obtained by a GPS receiver of the mobile user device. For instance, the GPS receiver may poll (e.g., periodically or in response to some event) GPS satellites for location information, which may be forwarded to the requester. In this example, the location information is only provided to the requester if the user of the mobile user device has elected to participate in obtaining images for the application server.

In step 404, in this embodiment, an image request may be received from the requestor. The image request may include information associated with a target geographic element. For instance, the image request may include a location of the target geographic element, information about a user incentive (e.g., a description of the user reward or game reward if the application supports user incentives), and one or more target criteria (e.g., a resolution criterion, a location criterion, a composition criterion, a quality criterion, a time criterion) for obtaining an image of the target geographic element. The mobile user device may then generate guidance information (e.g., directions to the location, orientation requested for a camera to capture the image, etc.) based on the target criteria of the image request.

In step 406 of the present embodiment, aspects of the guidance information for obtaining the image are presented to the user. In one embodiment, the user device may display a video of the scene before its camera. The video feed may, for instance, be displayed on a display screen of the mobile device. The user device may overlay on the video guidance information, e.g., a graphical representation of aspects of the guidance information, such as a highlighted region indicating a desired camera orientation or position. In some embodiments, the user device may display some or all of the guidance information in prose. As noted above, the guidance information may be part of the image request. In this instance, the mobile user device augments the reality of the user as it is repositioned in the user's view. For example, as the user turns and repositions the camera, the graphical representation of aspects of the guidance information augment the video feed displayed on the display screen to guide the user to the proper orientation of the camera. Additionally, aspects of the user incentive may also be presented to encourage the user to obtain the image. For example, an information dialog including aspects of the user incentive may also be presented on the display of the mobile user device.

In some embodiments, the target highlight may be graphically presented in the context of a game as a game overlay that encourages the user to properly position the camera for capturing the image. For example, the game overlay may be a fluttering butterfly directing the user to orient the camera towards the target geographic element. The user device may overlay an image of the butterfly on the video feed from a camera. The position (or other attribute, such as size, color, or speed of movement) of the butterfly on the display may be adjusted based on a difference between a desired orientation of the camera (e.g., as specified by the image request) and an actual orientation of the camera, e.g., as sensed by an accelerometer of the user device. The position (or other attributes) of the butterfly may also be adjusted by the user device on the display based on a difference between a desired location of the user device (e.g., as specified by the image request) and a location of the user device. The user device may overlay on the video images depicting the butterfly being captured as the user device approaches the desired location and orientation. In another example, the game overlay may be a rampaging monster directing the user to orient the camera towards a building may be displayed.

In step 408 of the present embodiment, the image and location information are captured. For example, the image may be captured automatically when the user properly positions and orients the camera as directed based on the guidance in step 406, e.g., the camera may capture an image in response to a difference between a desired orientation and an actual orientation falling below an orientation threshold and a difference between a desired location and an actual location falling below a location threshold. In another example, the guidance of step 406 may direct the user to orient the camera, where instructions are displayed directing the user to manually capture the image when the user properly orients the camera. In both examples, geographic coordinates of the user's current location may be determined and associated with (e.g., related to) the captured image.

Alternatively, the image may be captured by a camera that is separate from the mobile user device. For example, the user may use a standard camera to capture the image, which may then be uploaded to the mobile user device or some other computing device. Once uploaded, the image may then be processed and provided to the requester as discussed below.

In step 410 of the current embodiment, a determination may be made as to whether the Image satisfies image request criteria. In the case that target criteria are included in the image requests of step 404, the determination may be performed locally by the user device based on the specified target criteria. Alternatively, or additionally, a request to verify whether the image satisfies target geographic element criteria may be submitted to the requester. If it is determined that the image does not satisfy the target geographic element criteria, the reason the image failed to satisfy the criteria may be displayed for review by the user in step 412. After the user reviews the reason the image failed to satisfy the criteria, the workflow proceeds to step 406 so that the user may attempt to capture a new image that satisfies the target geographic element criteria.

In some embodiments, confirmation of a user reward may be displayed for the user after it is determined that the image satisfies the image request criteria. For example, in the case where the guidance is presented in the context of a game, the confirmation may notify the user that he has been awarded with achievement points or a virtual trophy for obtaining the image. In another example, the user may be notified that he has been awarded a social reward on a social networking service. In this example, other users of the social networking service may be notified of the user's social reward to encourage the other users to participate. The other users may be notified with an invitation to participate that is sent on behalf of the user. For example, the invitation to participate may include (1) a notification of the amount of funds (virtual or actual) earned by the user for obtaining the image and (2) a hyperlink for the other users to register with the application server. In another example, the invitation to participate may include (1) a notification of a rank of the user within a social network after obtaining the image and (2) a hyperlink for the other users to register with the application server.

Alternatively, if it is determined that the image does satisfy the target geographic element criteria, the image and associated location information is sent to the requester in step 414. In some embodiments, if the image was previously submitted to the requester in step 410 in order to verify the image, step 414 may be omitted from the workflow.

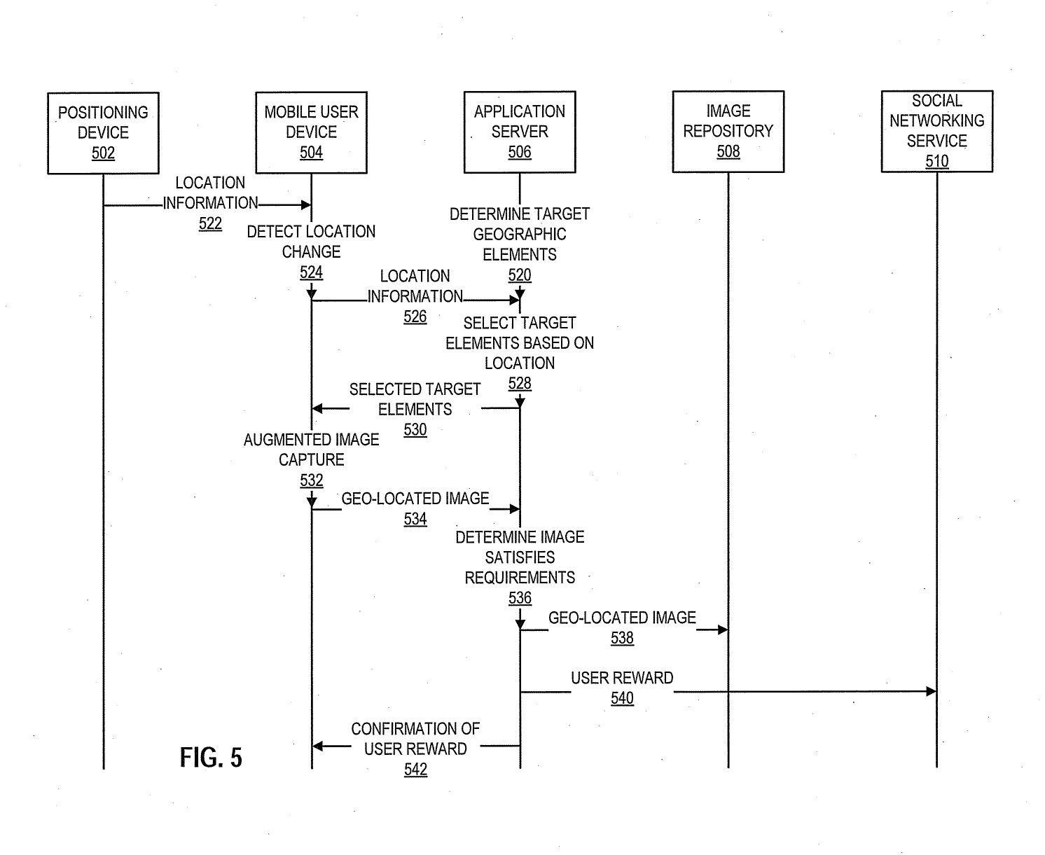

FIG. 5 shows another example in accordance with embodiments of obtaining images to enhance imagery coverage. More specifically, FIG. 5 shows an example of obtaining images for an application server. The example includes a positioning device 502, a mobile user device 504, an application server 506, an image repository 508, and a social networking service 510, which may be substantially similar to their corresponding components discussed above with respect to FIGS. 1 and 2.

In step 520 of the present embodiment, the application server 506 may determine target geographic elements (e.g., target points of interest, target geographic areas) that are lacking imagery based on spatial data. For instance, the application server 506 performs a spatial query to determine if additional images should be requested for points of interest or geographic areas. In the case of geographic areas, the application server may determine if a geographic area has a sufficient number of images based on an image threshold, e.g., a preconfigured image threshold. For example, the application server 506 may determine that additional images should be requested for a geographic area if the geographic area does not have a specified quantity of images per unit area or per capita. In some embodiments, the application server 506 may be configured to favor (e.g., select with a higher frequency or select according to a more lenient threshold) geographic areas with higher populations relative to lower population areas when determining target geographic elements.

In step 522 of the present embodiment, location information may be transmitted from the positioning device 502 to the mobile user device 504. In this example, the positioning device 502 is a GPS, and the location information is radio frequency (“RF”) signals that the mobile user device 504 uses to determine its absolute location. In step 524, the mobile user device 504 may monitor its location by periodically polling the GPS in order to detect a location change of the mobile user device 504. In 526, when a location change is detected, the mobile user device 504 of this embodiment sends its current location information to the application server 506.

In step 528, in this embodiment, the application server 506 may select nearby target geographic elements from the targets determined in step 520 based on the location information provided by the mobile user device 504. The selection may be performed by executing a spatial query for all target geographic elements within a radius surrounding the geographic coordinates specified in the location information provided by the mobile user device 504. Further, a spatial query may also be used by the application server (506) to determine user rewards for the target geographic elements. For example, the magnitude or scarcity of the user reward may monotonically increase (e.g., proportionally to, etc.) according to the distance between the geographic coordinates specified in the location information and the location of the target geographic elements, encouraging users to travel farther distances. In another example, the magnitude or scarcity of the user reward may be directly proportional to the quantity of users of the map service that have requested an image of the target geographic elements. In this example, the users of the map service request the image by making selections from a map showing candidate geographic elements from the map service

In step 530 of this embodiment, the application server 506 may send the nearby target geographic elements to the mobile user device 504. For example, image requests may be generated by the application server 506 based on the target geographic elements, and the image requests may then be sent over a wide area network (e.g., Internet) to the mobile user device 504. In this example, the mobile user device 504 may be connected to the wide area network via, for example, a wireless internet connection or a cellular connection. Associated user rewards and guidance for obtaining images for the target geographic elements may also be sent to the mobile user device 504 in the image requests. In this example, guidance for obtaining an image for a target geographic element may include (1) directions for navigating the user of the mobile user device 504 to the location of the target geographic element and (2) the orientation suggested for the camera to capture the image of the target geographic element.

In step 532 of this embodiment, an augmented image capture may be performed on the mobile user device 504 by capturing an image with instructions overlaid on a video from the camera. A list of the nearby target geographic elements may be displayed on the mobile user device 504, and the user may select from the displayed targets a nearby target geographic element to initiate the augmented image capture. Users, in some embodiments, are expected to base their selections on the user's distance from each of the nearby target geographic elements and user reward information displayed for each of the nearby target geographic elements. The mobile user device 504 may then guide the user to capture the requested image by augmenting a video stream captured by the camera. The video stream may be augmented by overlaying information from the guidance on the video stream, and the guidance may be updated in real-time (e.g., near real-time, e.g., more than once per second) as the mobile user device 504 is repositioned. Once the camera is located at the target geographic element and orientated as requested by the application server 506, the mobile user device 504 may capture the image automatically or signal the user (e.g., by vibrating, alarming, or changing the display) to capture the image manually. When the image is captured, location information may also be obtained. The location information (e.g., geographic location and orientation) may describe the geographic coordinates of the image and the orientation of the camera when the image was captured.

In step 534 of this embodiment, the mobile user device 504 may send the geo-located image to the application server 506. In response to receiving the image, the application server 506 may determine whether the image satisfies target geographic element criteria in step 536. For example, the application server 506 may determine whether the image was captured at the location of the target geographic element and whether the camera was properly oriented when capturing the image. The orientation of the camera may be verified by analyzing location information provided by the mobile user device 504 or by performing object recognition on the image to determine, for example, if a target point of interest is depicted in the image and the location information matches the requested location. After determining that the image satisfies the target geographic element criteria, the application server 506 may store the geo-located image in the image repository 508 in step 538.

The stored geo-located images may then be used for a variety of purposes, including to provide map services. For example, a map service may provide the user-generated images when displaying points of interest such as, but not limited to, tourist attractions, restaurants, museums, etc. displayed on a map. In another example, the stored images may be used to perform data collection for various analysis such as identifying the presence or color of foliage, evaluating indicia of business performance (e.g., counting items in inventory or number of cars in a parking lot), evaluating indicia of the popularity of an event (e.g., counting the number of people attending the event), measuring the dimensions of an object for three-dimensional modeling, etc.

In step 540, in this embodiment, the application server 506 may submit the user reward to the social networking service 510. For example, the application server 506 may award achievement points to the user of the mobile user device for obtaining the image 504 and then notify the social networking service 510 of the achievements points to share with other users of the social networking service. In another example, the application server 506 may send a request to the social networking service 510 to provide the user with a social reward for obtaining the image. In this example, the social reward may be a virtual trophy or points awarded in a gaming application provided by the social networking service.

After the user reward is awarded to the user, in this embodiment, the application server 506 may send confirmation of the user reward to the mobile user device 504 in step 542. The mobile user device 504 may then display the confirmation for review by the user of the mobile user device 504.

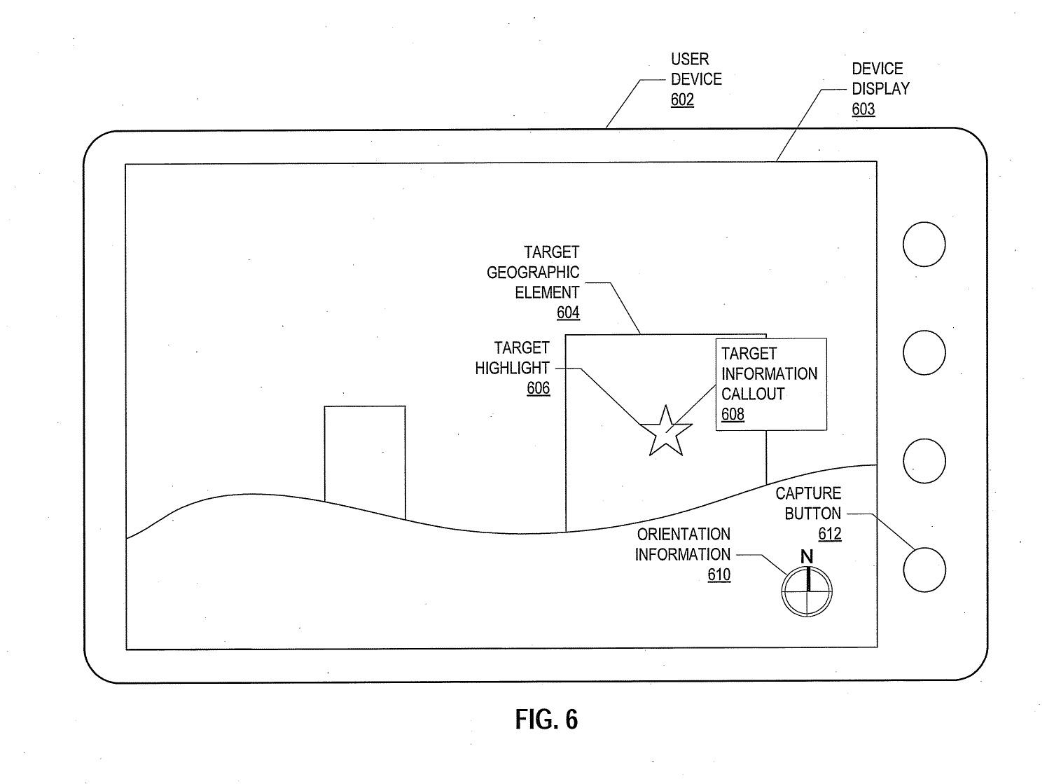

FIG. 6 shows an example interface in accordance with embodiments of obtaining images to enhance imagery coverage. More specifically, FIG. 6 shows an example user interface for performing augmented image capture on a mobile user device 602.

The mobile user device 602 includes a device display 603 displaying an augmented video stream provided by a camera, such as an image capture device disposed facing out, away from a rear face of the user device 602 of FIG. 6, which is into the page in the view of FIG. 6. Examples of device display 604 technologies include multi-touch capacitive screens, organic light emitting diode (OLED) screens, etc. The augmented video stream may show a target geographic element 604, which is a building in this example. Overlaid on the target geographic element 604 is a target highlight 606 directing the user to reposition the camera. In this case the target highlight 606 is in the right portion of the device display 603 to direct the user to rotate his user device 602 to the right in order to center the target geographic element 604.

In some embodiments, the augmented video stream may be generated by the mobile user device 602 based on an analysis of stored frames of the video stream or motions sensors such as accelerometers and magnetometers. Object recognition of the stored frames may be performed by the mobile user device 602 to identify the target geographic element 604. Additionally, the target geographic element 604 may be tracked in the video stream based on the orientation information from the motion sensors. For example, as the mobile user device 602 is repositioned, the mobile user device 602 may predict the movement of the target geographic element 604 based on the orientation information and repositions the target highlight 606 accordingly.

In this embodiment, the augmented video stream on the device display 603 also shows a target information callout 608. The target information callout 608 may display information such as the user reward provided for capturing an image of the target geographic element 604, a description of the target geographic element 604, and text instructions for repositioning the mobile user device 602 to have the proper orientation. Orientation information 610 may also be separately displayed in the video stream as, for example, a real-time compass highlighting the direction of the target geographic element 604. When the mobile user device 602 is correctly positioned, a visual cue may be displayed on the device display 603 requesting that the user to capture the image. The mobile user device 602 may also include a capture button 612 that is pressed by the user to instruct the mobile user device 602 to capture the image of the target geographic element 604.

While obtaining images to enhance imagery coverage has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present embodiments may suitably comprise, consist or consist essentially of the elements disclosed and may be practiced in the absence of an element not disclosed.

As used throughout this application, the word “may” is used in a permissive sense (i.e., meaning having the potential to), rather than the mandatory sense (i.e., meaning must). The words “include”, “including”, and “includes” mean including, but not limited to. As used throughout this application, the singular forms “a”, “an” and “the” include plural referents unless the content clearly indicates otherwise. Thus, for example, reference to “an element” includes two or more elements. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical electronic or magnetic quantities within memories, registers, or other information storage devices, transmission devices, or display devices of the special purpose computer or similar special purpose electronic processing/computing device.

We claim:

1. A method of obtaining images to enhance imagery coverage, the method comprising:
identifying by one or more processors a plurality of target geographic elements that fail to satisfy an image threshold based on spatial data;
generating by the one or more processors a plurality of image requests, each of the plurality of image requests being associated with a target geographic element of the plurality of target geographic elements;
transmitting by the one or more processors an image request of the plurality of image requests to a mobile user device, the image request comprising a geographic location of the target geographic element;
receiving by the one or more processors an image of the target geographic element from the mobile user device; and
storing the image in an image repository so that the imagery coverage includes the image of the target geographic element.

2. The method of claim 1, further comprising:
determining that the image satisfies criteria of the target geographic element, the criteria comprising at least one criterion of a group consisting of a resolution criterion, a location criterion, a composition criterion, a quality criterion, and a time criterion,
wherein the image is associated with the target geographic element after determining that the image satisfies the criteria.

3. The method of claim 1, further comprising:
receiving an initial location of the mobile user device from the mobile user device; and
transmitting the image request from the plurality of image requests based on the initial location so that a user of the mobile user device is within a predetermined distance of the geographic location.

4. The method of claim 3, wherein the image request further comprises a user reward that is determined based on a distance between the initial location and a target location of the image.

5. The method of claim 1, further comprising:
determining a plurality of revised target geographic elements failing to satisfy the image threshold based on the image; and
generating a plurality of revised image requests, each of the plurality of revised image requests being associated with one of the plurality of revised target geographic elements.

6. The method of claim 1, further comprising:
transmitting candidate geographic elements to users of a map service; and
receiving user requests for the image of the target geographic element from the users of the map service.

7. The method of claim 6, wherein the image request further comprises a user reward that is determined based on a quantity of the users submitting the user requests for the image of the target geographic element.

8. The method of claim 1, wherein the geographic location includes geographic coordinates determined based on a signal from a positioning device.

9. The method of claim 1, wherein the target geographic element is a target point of interest, wherein the image is stored after determining that the image depicts the target point of interest.

10. The method of claim 9, wherein determining that the image depicts the target point of interest comprises:
receiving orientation information and an image location of the image from the mobile user device; and
determining the image depicts the target point of interest based on the orientation information and the image location.

11. The method of claim 9, wherein determining that the image depicts the target point of interest comprises:
performing object recognition on the image to identify the target point of interest in the image.

12. The method of claim 1, wherein the target geographic element is one selected from a group consisting of a target point of interest and a target geographic area.

13. The method of claim 1, wherein the target geographic element is a target geographic area, and wherein the image threshold specifies a minimum quantity of images for the target geographic area.

14. A method of obtaining images, the method comprising:
receiving at a user device an image request associated with a target geographic element, the image request comprising guidance for obtaining an image of the target geographic element;
displaying the guidance for obtaining the image on a video display of the user device, the guidance overlaying a video stream from a camera of a user;
capturing the image of the target geographic element;
determining a location of the user device; and
transmitting the image and the location to an application server.

15. The method of claim 14, wherein displaying the guidance for obtaining the image comprises:
performing object recognition of a stored frame of the video stream to identify a target location of the image request; and
presenting a target highlight over the target location in the video stream.

16. The method of claim 15, further comprising:
determining an orientation of the camera; and
repositioning the target highlight to remain over the target location as the orientation of the camera changes.

17. The method of claim 15, further comprising:
determining an orientation of the camera; and
displaying a direction highlight based on the orientation for directing the camera towards the target location.

18. The method of claim 15, further comprising sending an initial location of the user device to the application server, wherein the image request further comprises a user reward that is determined based on a distance between the initial location and the target location of the image.

19. The method of claim 18, further comprising:
displaying target annotations comprising a description of the user reward on the video display.

20. The method of claim 18, wherein the user reward is a social reward of a social networking service.

21. The method of claim 14, wherein the location is a global location determined based on a global positioning system signal.

22. A system, comprising:
one or more memories;
one or more processors, each operatively connected to at least one of the one or more memories;
a device interface stored on the one or more memories, the device interface being executed by the one or more processors to:
transmit an image request of a plurality of image requests to a mobile user device, the image request comprising guidance for obtaining an image of a target geographic element of a plurality of target geographic elements; and
receive the image of the target geographic element from the mobile user device;
a target manager module stored on the one or more memories, the target manager module being executed by the one or more processors to:
identify the plurality of target geographic elements that fail to satisfy an image threshold based on spatial data; and
generate the plurality of image requests, each of the plurality of image requests being associated with the target geographic element; and
an image repository in which the image of the target geographic element is stored so that an imagery coverage of the image repository includes the image.

23. The system of claim 22, further comprising an image manager module stored on the memory, the image manager module being executed by the one or more processors to:
determine that the image satisfies criteria of the target geographic element, the criteria comprising at least one criterion of a group consisting of a resolution criterion, a location criterion, a composition criterion, a quality criterion, and a time criterion,
wherein the image is associated with the target geographic element after determining that the image satisfies the criteria.

24. The system of claim 22, further comprising a location manager module stored on the memory, the location manager module being executed by the one or more processors to:
receive an initial location from the mobile user device; and
transmitting to the mobile user device the image request from the plurality of image requests based on the initial location.

25. The system of claim 24, the location manager module being further executed by the processor to generate a user reward based on a distance between the initial location and a target location of the image.

26. The system of claim 22, the target manager module being further executed by the one or more processors to:
determine a plurality of revised target geographic elements failing to satisfy the image threshold based on the image; and
generate a plurality of revised image requests, each of the plurality of revised image requests being associated with one of the plurality of revised target geographic elements.

27. The system of claim 22, wherein the target geographic element is a target point of interest, wherein the image is stored after the target manager module is further executed by the processor to determine that the image comprises the target point of interest.

28. The system of claim 22, wherein the image threshold specifies a minimum quantity of images for the target geographic element.

29. The system of claim 22, further comprising the user device to:
receive the image request associated with the target geographic element from the device interface;
display the guidance for obtaining the image on a video display of the user device, the guidance overlaying a video stream from a camera of the user device;
capture the image for the image request;
determine a location of the user device; and
transmit the image and the location to the device interface.

30. A non-transitory computer readable medium having computer-executable program instructions embodied therein causing one or more computer processors to:
identify a plurality of target geographic elements that fail to satisfy an image threshold based on spatial data;
generate a plurality of image requests, each of the plurality of image requests being associated with a target geographic element of the plurality of target geographic elements;
transmit an image request of the plurality of image requests to a mobile user device, the image request comprising guidance for obtaining an image of the target geographic element;
receive the image of the target geographic element; and
store the image of the target geographic element in an image repository so that an imagery coverage of the image repository includes the image.

31. The computer readable medium of claim 30, the computer-executable program instructions further causing the computer processor to:
determine that the image satisfies criteria of the target geographic element, the criteria comprising at least one criterion of a group consisting of a resolution criterion, a location criterion, a composition criterion, a quality criterion, and a time criterion,
wherein the image is associated with the target geographic element after the determining that the image satisfies the criteria.

32. The computer readable medium of claim 30, the computer-executable program instructions further causing the computer processor to:
receive an initial location from the mobile user device; and
select the image request from the plurality of image requests based on the initial location.

33. The computer readable medium of claim 30, the computer-executable program instructions further causing the computer processor to:
determine a plurality of revised target geographic elements failing to satisfy the image threshold based on the image; and
generate a plurality of revised image requests, each of the plurality of revised image requests being associated with one of the plurality of revised target geographic elements.

34. The computer readable medium of claim 30, wherein the target geographic element is a target point of interest, wherein the image is stored after determining that the image comprises the target point of interest.

35. The computer readable medium of claim 34, wherein the computer processor determines that the image comprises the target point of interest by:
receiving orientation information and an image location of the image from the mobile user device; and
determining the image comprises the target point of interest based on the orientation information and the image location.

36. The computer readable of claim 34, wherein the computer processor determines that the image comprises the target point of interest by:
performing object recognition on the image to identify the target point of interest in the image.

37. A non-transitory computer readable medium having computer-executable program instructions embodied therein causing a computer processor to:
receive at a user device an image request associated with a target geographic element, the image request comprising guidance for obtaining an image of the target geographic element;
display the guidance for obtaining the image on a video display of the user device, the guidance overlaying a video stream from a camera of the user device;
capture the image for the image request;
determine a location of the user device; and
transmit the image and the location to an application server.
